(19) United States
(12) Patent Application Publication
(10) Pub. No.: US 2025/0207712 A1
(43) Pub. Date: Jun. 26, 2025

(54) FLUID PULSATION DAMPENERS FOR VISCOUS FLUIDS

(71) Applicant: BLACOH FLUID CONTROLS, INC., Riverside, CA (US)

(72) Inventor: David Dean McComb, Highland, CA (US)

(21) Appl. No.: 18/986,296

(22) Filed: Dec. 18, 2024

Related U.S. Application Data
(60) Provisional application No. 63/613,266, filed on Dec. 21, 2023.

(51) Int. Cl. F16L 55/053

(52) U.S. Cl. CPC F16L 55/053

(57) ABSTRACT

A fluid pulsation dampener includes a housing; a piston moveable with respect to the housing along a first direction between an extended position and a retracted position, a gas chamber that is exposed to a first end of the piston; a liquid chamber that is exposed to a second end of the piston; a fluid inlet passage and a fluid outlet passage for fluidly coupling the fluid pulsation dampener to a fluid pumping system in a flow-through arrangement, the fluid inlet passage and the fluid outlet passage extending in a direction perpendicular to the first direction, wherein the piston is shaped such that, with the piston in the retracted position, a lowest point of the piston is tangent to or close to tangent to an inner surface of at least one of the fluid inlet passage or the fluid outlet passage.

### CROSS-REFERENCE TO RELATED APPLICATIONS

This application claims the benefit of U.S. Provisional Application No. 63/613,266, titled FLUID PULSATION DAMPENERS FOR VISCOUS FLUIDS, filed on Dec. 21, 2023, which is hereby incorporated by reference herein in its entirety.

### BACKGROUND

### Field

This disclosure generally relates to systems, methods, and devices for dampening pulsations in fluid piping systems.

### Description

Hydraulic systems, such as fluid piping systems, are used to transport fluid under pressure in various applications. A fluid pump used in such systems creates pulsations that can cause a number of issues, including wearing out components of the pump and other portions of the system over time. A fluid pulsation dampener can be used to smooth out the fluid flow by absorbing such pulsations and providing extra pressure when needed.

### SUMMARY

The disclosure herein provides various embodiments of fluid pulsation dampeners that are designed for, or particularly well-suited for, use with viscous and/or thick fluids at extreme temperatures (such as, for example, at temperatures within a range of 20° F. to 446° F.). Various embodiments comprise a piston dampener design that can, among other things, maintain relatively consistent performance across a range of a stroke of the piston, and help keep internal walls of the dampener clean during use. Various embodiments also comprise a piston dampener design wherein all materials that come into contact with the liquid being pumped are capable of withstanding high temperatures, such as up to 446° F. or more, without damage.

A fluid pulsation dampener comprises: a housing having a first end and a second end; a first cap connected to the first end of the housing; a second cap connected to the second end of the housing; a cylindrical sleeve having a first end and a second end, the cylindrical sleeve positioned within the housing and captured between the first cap and the second cap; a piston having a first end and a second end, the piston being slidably coupled to the cylindrical sleeve such that the piston can move between an extended position and a retracted position, wherein the first end of the piston comprises a first U-cup seal that seals against an interior surface of the cylindrical sleeve, and the second end of the piston comprises a second U-cup seal that seals against the interior surface of the cylindrical sleeve; a liquid chamber defined at least partially by the second cap, the second end of the piston, and a portion of the interior surface of the cylindrical sleeve that is between the second cap and the second end of the piston; a fluid inlet passage and a fluid outlet passage for fluidly coupling the fluid pulsation dampener to a fluid pumping system in a flow-through arrangement, the fluid inlet passage and the fluid outlet passage being in fluid communication with the liquid chamber and extending in a direction perpendicular to a direction along which the cylindrical sleeve extends, wherein the piston is shaped such that, with the piston in the retracted position: a lowest point of the piston is tangent to an inner surface of at least one of the fluid inlet passage or the fluid outlet passage, or the lowest point of the piston is a distance from tangent to the inner surface of the at least one of the fluid inlet passage or the fluid outlet passage, with the distance being no more than 20% of a diameter of the inner surface of the at least one of the fluid inlet passage or the fluid outlet passage; a first gas chamber defined at least partially by the first cap, the first end of the piston, and a portion of the interior surface of the cylindrical sleeve that is between the first cap and the first end of the piston; a second gas chamber positioned within an annular space between the cylindrical sleeve and the housing, the second gas chamber defined at least partially by the first cap, the second cap, an interior surface of the housing, and an exterior surface of the cylindrical sleeve; one or more openings that fluidly couple the first gas chamber to the second gas chamber; and a proximity sensor coupled to the second cap, wherein the piston further comprises a magnet, and wherein the proximity sensor is positioned such that it can detect the magnet of the piston, at least when the piston is in the retracted position.

In some embodiments, all parts of the fluid pulsation dampener that define the liquid chamber are capable of being exposed to a liquid heated to a temperature of 446° F. without damage. In some embodiments, at least the second U-cup seal comprises a perfluoroelastomer material. In some embodiments, the piston comprises a main body, a first cap, and a second cap, wherein the main body and the first cap of the piston form an annular groove therebetween within which first U-cup seal is positioned, and wherein the main body and the second cap of the piston form an annular groove therebetween within which second U-cup seal is positioned. In some embodiments, the piston comprises a flat bottom. In some embodiments, the interior surface of the cylindrical sleeve comprises a honed surface. In some embodiments, the fluid pulsation dampener further comprises a fill valve coupled to the first cap for introducing pressurized gas into the first gas chamber and the second gas chamber. In some embodiments, the cylindrical sleeve and a main body of the piston each comprise a material having a same coefficient of thermal expansion. In some embodiments, the cylindrical sleeve and a main body of the piston each comprise stainless steel. In some embodiments, the piston can move in a first direction, toward the first end of the housing, and in a second, opposite direction, toward the second end of the housing, wherein the first cap comprises a surface positioned to limit movement of the piston in the first direction, and wherein the one or more openings that fluidly couple the first gas chamber to the second gas chamber are positioned beyond the surface of the first cap in the first direction. In some embodiments, the first end of the cylindrical sleeve is positioned within a groove of the first cap that extends beyond the surface of the first cap in the first direction. In some embodiments, the first end of the cylindrical sleeve comprises the one or more openings that fluidly couple the first gas chamber to the second gas chamber.

According to some embodiments, a fluid pulsation dampener comprises: a housing having a first end and a second end; a piston having a first end and a second end, the piston being moveable with respect to the housing along a first direction between an extended position and a retracted position, a gas chamber that is exposed to the first end of the piston; a liquid chamber that is exposed to the second end of the piston, wherein the piston comprises one or more seals that seal the gas chamber from the liquid chamber; a fluid inlet passage and a fluid outlet passage for fluidly coupling the fluid pulsation dampener to a fluid pumping system in a flow-through arrangement, the fluid inlet passage and the fluid outlet passage being in fluid communication with the liquid chamber and extending in a direction perpendicular to the first direction, wherein the piston is shaped such that, with the piston in the retracted position: a lowest point of the piston is tangent to an inner surface of at least one of the fluid inlet passage or the fluid outlet passage, or the lowest point of the piston is a distance from tangent to the inner surface of the at least one of the fluid inlet passage or the fluid outlet passage, with the distance being no more than 20% of a diameter of the inner surface of the at least one of the fluid inlet passage or the fluid outlet passage.

In some embodiments, the second end of the piston comprises a flat surface, and the lowest point of the piston is defined by the flat surface. In some embodiments, the one or more seals of the piston comprises at least one U-cup seal comprising a perfluoroelastomer material. In some embodiments, all parts of the fluid pulsation dampener that define the liquid chamber are capable of being exposed to a liquid heated to a temperature of 446° F. without damage. In some embodiments, the piston further comprise a magnet, and where the fluid pulsation dampener further comprises a proximity sensor positioned such that it can detect the magnet of the piston, at least when the piston is positioned in the retracted position.

According to some embodiments, a fluid pulsation dampener comprises: a housing having a first end and a second end; a first cap connected to the first end of the housing; a second cap connected to the second end of the housing; a cylindrical sleeve having a first end and a second end, the cylindrical sleeve positioned within the housing; a piston having a first end and a second end, the piston being slidably coupled to the cylindrical sleeve such that the piston can move between a retracted position and an extended position, and the piston comprising one or more seals that seal against an interior surface of the cylindrical sleeve; a liquid chamber defined at least partially by the second cap, the second end of the piston, and a portion of the interior surface of the cylindrical sleeve that is between the second cap and the second end of the piston; one or more fluid ports in fluid communication with the liquid chamber; a first gas chamber defined at least partially by the first cap, the first end of the piston, and a portion of the interior surface of the cylindrical sleeve that is between the first cap and the first end of the piston; a second gas chamber positioned within a space between the cylindrical sleeve and the housing, the second gas chamber defined at least partially by an interior surface of the housing and an exterior surface of the cylindrical sleeve; one or more openings that fluidly couple the first gas chamber to the second gas chamber; and a proximity sensor coupled to the second cap, wherein the piston further comprises a magnet, and wherein the proximity sensor is positioned such that it can detect the magnet of the piston, at least when the piston is in the retracted position.

In some embodiments, the cylindrical sleeve is captured between the first cap and the second cap. In some embodiments, the piston can move in a first direction, toward the first end of the housing, and in a second, opposite direction, toward the second end of the housing, and wherein the one or more openings that fluidly couple the first gas chamber to the second gas chamber are positioned beyond a furthest position any of the one or more seals of the piston can move to in the first direction. In some embodiments, the first end of the cylindrical sleeve is positioned within a groove of the first cap, and wherein the first end of the cylindrical sleeve comprises the one or more openings that fluidly couple the first gas chamber to the second gas chamber. In some embodiments, the cylindrical sleeve and a main body of the piston each comprise a material having a same coefficient of thermal expansion. In some embodiments, the cylindrical sleeve and a main body of the piston each comprise stainless steel. In some embodiments, the one or more seals of the piston comprises at least one U-cup seal comprising a perfluoroelastomer material.

For purposes of this summary, certain aspects, advantages, and novel features of the inventions are described herein. It is to be understood that not necessarily all such advantages may be achieved in accordance with any particular embodiment of the inventions. Thus, for example, those skilled in the art will recognize that the inventions may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the present disclosure are described in detail below with reference to the drawings of various embodiments, which are intended to illustrate and not to limit the disclosure. The features of some embodiments of the present disclosure, which are believed to be novel, will be more fully disclosed in the following detailed description. The following detailed description may best be understood by reference to the accompanying drawings wherein the same numbers in different drawings represents the same parts. All drawings are schematic and are not intended to show any dimension to scale. The drawings comprise the following figures, in which:

FIG. 1A is a front view of an embodiment of a fluid pulsation dampener.

FIG. 1B is a side view of the pulsation dampener of FIG. 1A.

FIG. 1C is a cross-sectional view of the pulsation dampener of FIG. 1A.

FIG. 1D is an enlarged view of a portion of the cross-sectional view of FIG. 1C.

FIG. 1E is another cross-sectional view of the pulsation dampener of FIG. 1A.

FIG. 1F is a partially exploded view of the pulsation dampener of FIG. 1A.

FIG. 2 is a schematic diagram of an embodiment of a fluid piping system that comprises the pulsation dampener of FIG. 1A.

FIG. 3A is a cross-sectional view of a piston of the pulsation dampener of FIG. 1A.

FIG. 3B is an exploded view of the piston of the pulsation dampener of FIG. 1A.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and include other uses of the inventions and obvious modifications and equivalents thereof. Embodiments of the inventions are described with reference to the accompanying figures, wherein like numerals refer to like elements throughout. These drawings are considered to be a part of the entire description of some embodiments of the inventions. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Fluid piping systems are used in various industries to transfer liquid such as water, gas, oil, chemicals, and/or the like. A pump is often used to transfer such fluid from an upstream portion of the piping system to a downstream portion. Positive displacement pumps, such as piston pumps, diaphragm pumps, peristaltic pumps, and others, tend to put out a pulsing flow. The pulses in the flow can cause problems in the system, and often a smoother flow is desirable.

One way to smooth out a fluid flow is to use a fluid pulsation dampener that includes a gas chamber that contains a pressurized gas. The fluid pulsation dampener may also include a bladder, bellows, or other deformable member that is in fluid communication with the pressurized gas on one side and with the fluid flow on the other side. Pulsations in the fluid flow may be absorbed by deforming the bladder and thus compressing the gas within the gas chamber. Such pulsation dampeners can be effective, but certain environments and/or fluids may be more difficult to use with such pulsation dampeners.

Specifically, transferring fluids that are thick and/or viscous present a challenge in many pumping environments, especially when elevated temperatures and pressures are required. For example, many use cases may require pumping a fluid that is solid at room temperature, and thus needs to be pumped at an elevated temperature, such as up to 446° F. or higher. Such high temperatures can be problematic for typical pulsation dampeners that may use, for example, a typical rubber bladder that may not be able to withstand such high temperatures without damage. Additionally, even at such high temperatures, such a fluid may remain relatively thick or viscous, may accumulate within the dampener over time, and may relatively quickly convert back into a solid when a fluid pumping system is turned off and/or if the fluid remains in the dampener for an extended period of time. This can be problematic, for example, because some of the solid substance may remain inside the chamber of the pulsation dampener. This may interfere with pumping system cleaning, may lead to requiring disassembly and cleaning of the pulsation dampener before the pumping system is turned back on, and/or or may reduce the dampening performance or efficiency of the pulsation dampener.

The disclosure herein provides various embodiments of pulsation dampeners that provide a variety of benefits, including addressing the above-described challenges experienced when attempting to pump fluids that become solid at room temperature. In some embodiments, a pulsation dampener utilizes a piston instead of a bladder to perform the dampening effect for a fluid pumping system. One side of the piston will be exposed to a gas charge set to a particular pressure, and another side of the piston will be exposed to the liquid fluid flow, in order to resist surges and other pressure transient events, absorbing excess energy of the pumped fluid and sending the fluid back into the system while simultaneously preventing damage to other pipeline component and instrumentation.

As mentioned above, various embodiments of fluid pulsation dampeners disclosed herein are intended to be able to pump a fluid that is a solid at room temperature. In such a case, the fluid pumping system will most likely operate at relatively high temperatures in order to transfer the fluid in a liquid state. Heating up a fluid usually decreases viscosity, making it easier to pump, but the materials of all pipeline components that come into contact with the heated fluid should be able to handle these higher temperatures as well. In order to address this, various embodiments disclosed herein are entirely created from materials that can withstand such higher temperatures, or at least components of the pulsation dampener that come into contact with the fluid being pumped are created from such materials. For example, some embodiments form a majority of the pulsation dampener from steel, such as stainless steel, and may utilize specialty high-performance polymers for sealing the piston. For example, some embodiments utilize perfluoroelastomer seals that can withstand extreme temperatures and extremely corrosive environments.

Additionally, various embodiments disclosed herein utilize U-cup seal rings for sealing the piston against an internal wall of the pulsation dampener. This can be desirable, for example, because as mentioned above it can be desirable for all (or at least a large percentage of) the fluid present in the main chamber or liquid chamber to be expelled from the pulsation dampener when the system is turned off (and/or when the liquid within the pulsation dampener is not presently experiencing a pressure pulsation or transient). U-cup seal rings comprise a lip that can be used to wipe the internal wall of the dampener as the piston completes each stroke. This wiping process can eliminate or virtually eliminate any excess fluid present inside of the dampener after a dampening stroke, keeping the dampener walls clean and ensuring correct system performance by preventing high viscosity fluids from solidifying within the dampener liquid chamber. Although various embodiments disclosed herein utilize U-cup seals for this function, other embodiments may utilize a different style of seal that includes a wiping lip and/or other embodiments may include a wiper in the piston that is separate from the seal. Further, other features of the pulsation dampener may also help with removing most or all of the fluid from the dampener after a dampening stroke. For example, as described further below, an opening adjacent the piston in a retracted position may be relatively large, such as at least as wide as the diameter of the piston.

Various embodiments disclosed herein also incorporate the ability to monitor the position of the piston within the pulsation dampener. This can be beneficial, for example, in order to confirm if the displacement of the piston is operating as intended and/or if the dampener needs to be adjusted, depending on the dampening performance desired for each individual application. Further, such monitoring may also be beneficial in order to know if, despite the wiping or cleaning features of the piston, some fluid has solidified within the pulsation dampener, thus causing the piston to not fully retract to its relaxed or fully retracted position. For example, some embodiments include a high-strength magnet attached to or incorporated within the piston, and a proximity sensor coupled to a housing, cap, or other part of the pulsation dampener in a location that enables the proximity sensor to detect the presence and/or position of the magnet. Such a design can be particularly beneficial in a pulsation dampener designed to be exposed to extreme temperatures and/or that includes a second gas chamber surrounding a primary gas chamber, because it would be difficult to include a transparent window or the like that could otherwise allow visual verification of the piston's position.

It should be noted that, although various embodiments described herein are particularly well-suited for use with viscous, corrosive, and/or high-temperature fluids, the embodiments described herein are not limited to use with such fluids and may also be used with more typical fluids (such as fluids that are less viscous and/or remain liquid at room temperature).

### Pulsation Dampening in Fluid Piping Systems

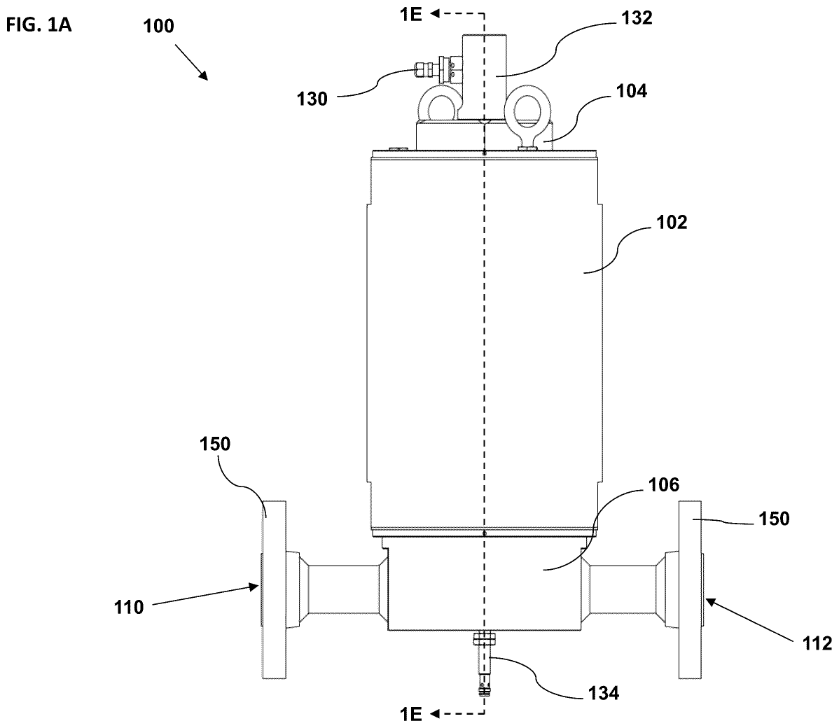

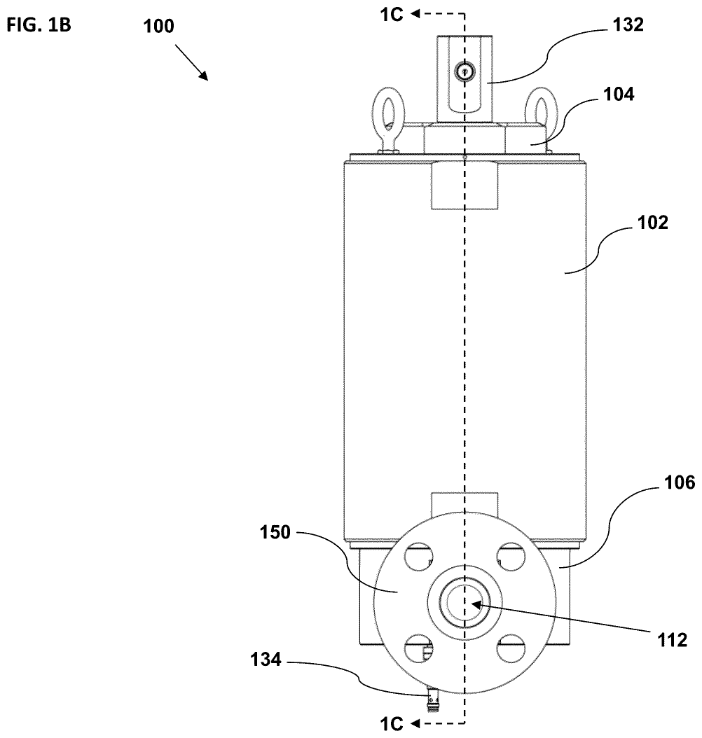

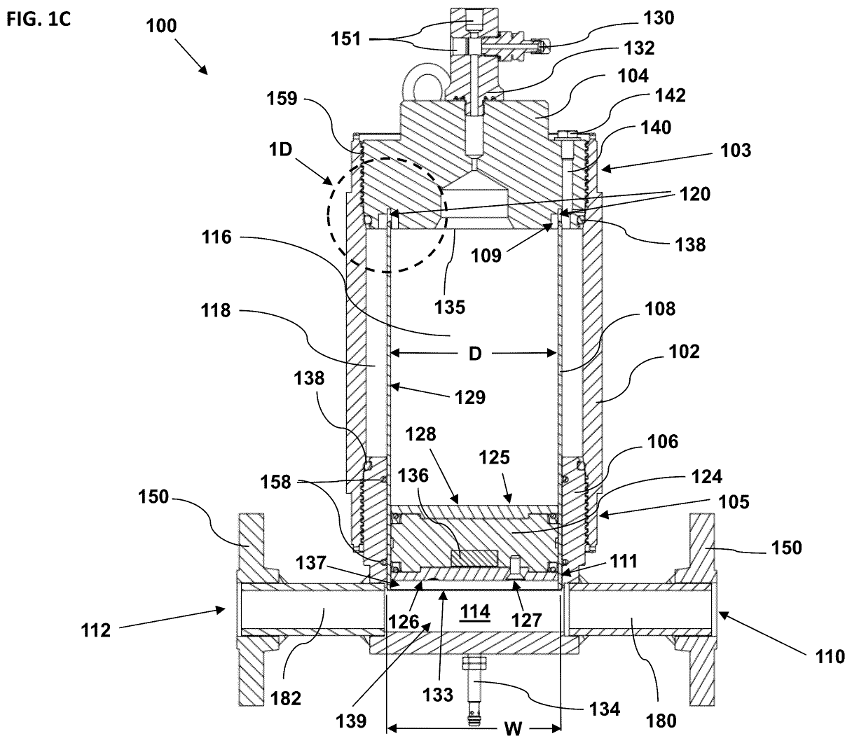

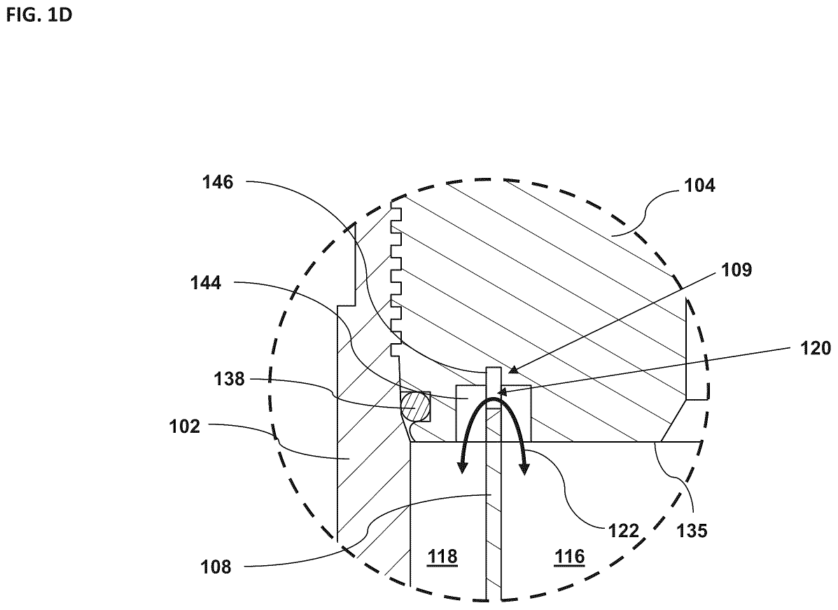

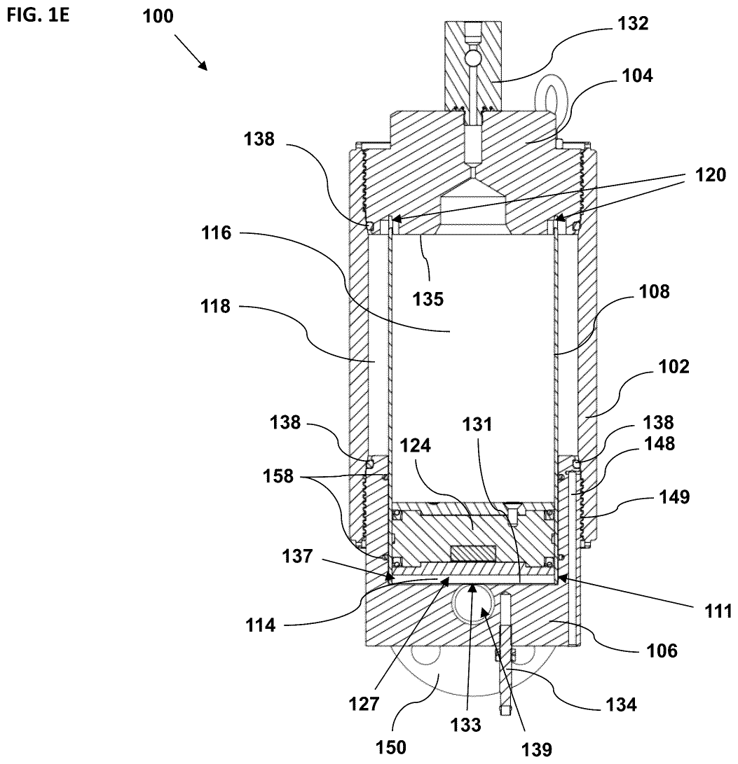

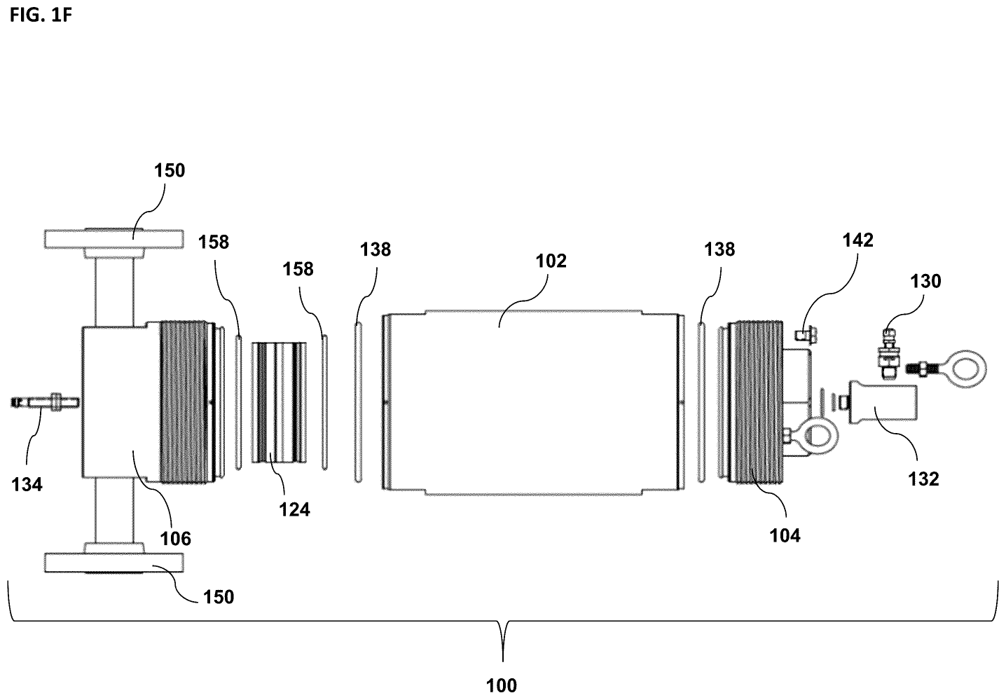

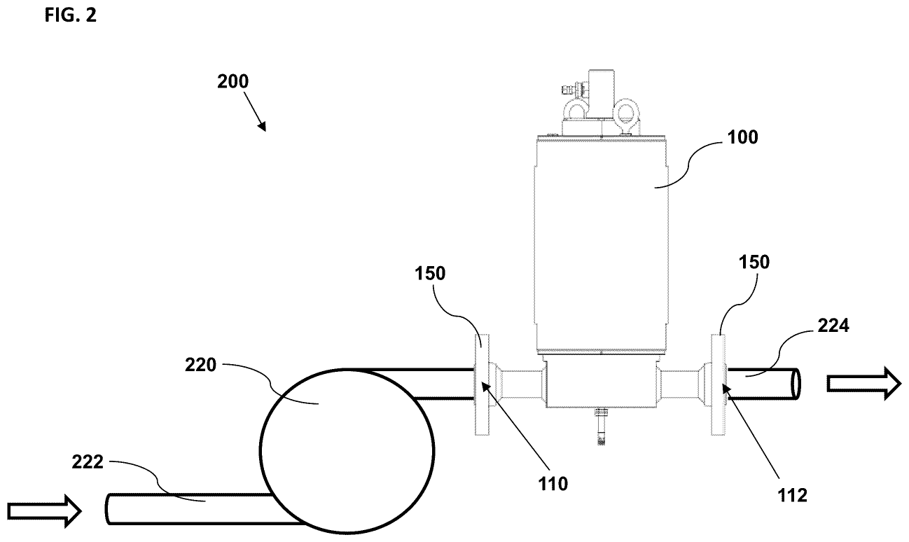

Turning to the figures, FIGS. 1A-1F illustrate one embodiment of a fluid pulsation dampener 100. FIG. 1A illustrates a front view of the pulsation dampener 100, FIG. 1B illustrates a side view, FIGS. 1C and 1E illustrate cross-sectional views, and FIG. 1D illustrates an enlarged view of a portion of the cross-sectional view of FIG. 1C. Additionally, FIG. 1F is a partially exploded view of the pulsation dampener 100. FIG. 2 illustrates a schematic diagram of the pulsation dampener 100 in use in a fluid piping system 200 (which may alternatively be referred to as a fluid pumping system). The schematic diagram of FIG. 2 is not shown to scale. The fluid piping system 200 comprises a pump 220 that is in fluid communication with upstream piping 222 and downstream piping 224. The pulsation dampener 100 is connected in fluid communication with the downstream piping 224, in a flow-through arrangement, in order to reduce and/or eliminate pulsations, vibrations, and/or the like in the fluid flow output from the pump 220. The pulsation dampener 100 may be used in fluid piping systems having various types of pumps 220, such as positive displacement, piston, diaphragm, peristaltic, centrifugal, metering, hose, air operated double diaphragm pumps, and/or the like.

The pulsation dampener 100 of FIG. 1C includes a fluid chamber 114, which is fluidly coupled to the downstream piping 224 of FIG. 2, and a piston 124 that at least partially defines a volume of the fluid chamber 114. Movement of the piston 124 changes a volume of the fluid chamber 114 that is in fluid communication with the fluid flowing through piping 224 of FIG. 2, and can help to absorb or dampen pulsations in the fluid flow.

In the fluid piping system 200 of FIG. 2, the pulsation dampener 100 is connected in a flow-through configuration, meaning that fluid flow from the downstream piping 224 enters the pulsation dampener 100 via one port (such as port 110 of FIG. 1C), and exits the pulsation dampener 100 via a second port (such as port 112 of FIG. 1C). The concepts disclosed herein are not limited to such arrangements, however, and could be used with a pulsation dampener configured in an appendage configuration (meaning that the pulsation dampener is connected in parallel with the output of the pump, using a single liquid inlet/outlet port through which fluid can enter and exit the fluid chamber of the pulsation dampener).

### Example Fluid Pulsation Dampener

With continued reference to FIGS. 1A-1F, additional details of the example embodiment of a fluid pulsation dampener 100 will now be provided. With reference to FIG. 1C, the pulsation dampener 100 comprises a housing 102 extending from a first end 103 to a second end 105. A first or top cap 104 is connected to the first end 103 of the housing 102, and a second or bottom 106 is attached to the second end 105 of the housing 102. In this embodiment, the top cap 104 and bottom cap 106 are threadedly engaged with the housing 102, and O-rings 138 are included to seal the top cap 104 and the bottom cap 106 to the housing 102. Other embodiments may connect the top cap 104 and/or bottom cap 106 differently, may seal them differently, and/or may incorporate some or all of the functionality of one or both of the top cap 104 or bottom cap 106 into the housing 102 itself.

With continued reference to FIG. 1C, the pulsation dampener 100 further comprises a cylindrical sleeve 108 (e.g., sleeve, member, wall, cylinder, or the like) extending from a first end 109 to a second end 111. In this embodiment, the cylindrical sleeve 108 is positioned within the housing 102 and is captured between the top cap 104 and the bottom cap 106. In other words, the first end 109 of the sleeve 108 is engaged with and held in place by the top cap 104, and the second end 111 of the sleeve 108 is engaged with and held in place by the bottom cap 106. The engagement of the second end 111 with the bottom cap 106 can be seen better in the cross-sectional view of FIG. 1E.

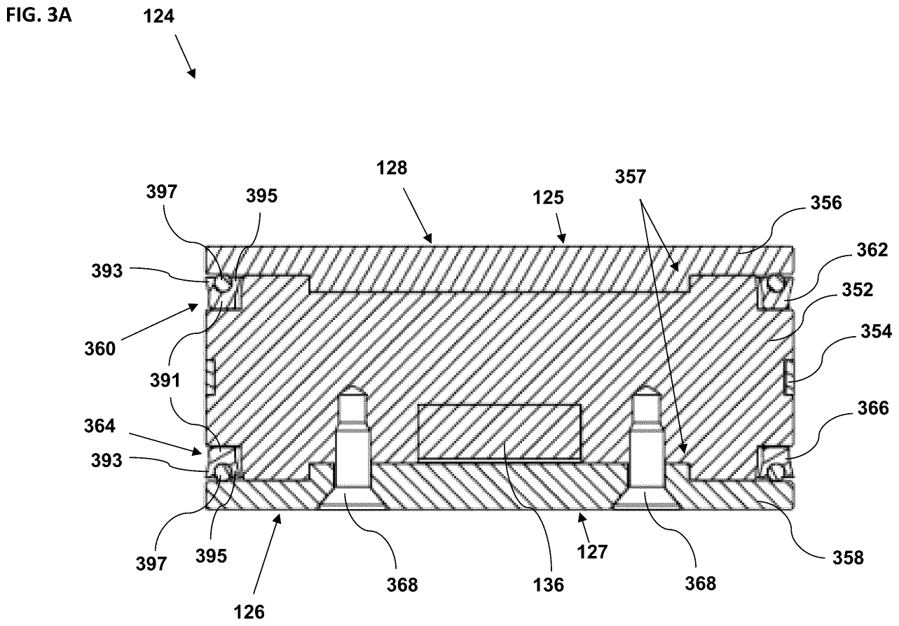

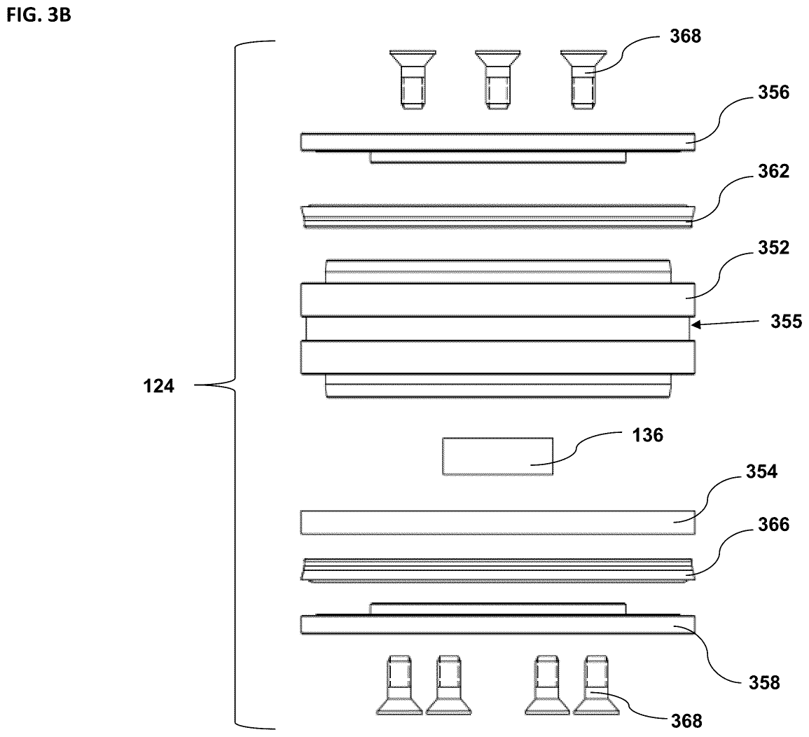

Returning to FIG. 1C, the pulsation dampener 100 further comprises a piston 124 slidably coupled to the cylindrical sleeve 108. The piston 124 extends from a first end 125 to a second end 127. At the first end 125 is a nonwetted side 128 (e.g., a side intended to be in contact with a gas), and at the second end 127 is a wetted side 126 (e.g., a side intended to be in contact with a liquid). As will be described in further detail below with reference to FIGS. 3A and 3B, the piston 124 comprises seals 362, 366 at the first end 125 and second end 127, respectively, that seal against an interior surface 129 of the cylindrical sleeve 108 in order to separate a gas chamber from a liquid chamber. Specifically, the pulsation dampener 100 comprises a liquid chamber 114 (also referred to herein as a fluid chamber 114) that is intended to be in fluid communication with a fluid pumping or piping system (such as the fluid piping system 200 of FIG. 2) in order to expose pulsations in the fluid flow to the piston 124. More specifically, in this embodiment, the fluid chamber 114 is in fluid communication with a fluid inlet port 110 and a fluid outlet port 112, each of which is configured to be coupled to a fluid piping system. For example, adjacent to each of the ports 110, 112 are flanges 150 that may be coupled to a fluid piping system. Other embodiments may couple the pulsation dampener to a fluid piping system differently.

The liquid chamber 114 in this embodiment is defined at least partially by the bottom cap 106, the second end 127 of the piston 124, and a portion of the interior surface 129 of the cylindrical sleeve 108 that is between the bottom cap 106 and the second end 127 of the piston 124. The piston 124 is configured to be able to slide back and forth within the cylindrical sleeve 108 from a retracted position to an extended position. In this embodiment, the piston 124 is shown in FIGS. 1C and 1E slightly above the fully retracted position. Specifically, the fully retracted position corresponds to when the second end 127 of the piston 124 comes into contact with a bottom surface 131 (see FIG. 1E) of the bottom cap 106. Likewise, a fully extended position corresponds to when the first end 125 of the piston 124 comes into contact with a top surface 135 of the top cap 104. The size or volume of the liquid chamber 114 can vary when the piston 124 moves, with the volume being the greatest when the piston 124 is at the fully extended position, and the volume being the least when the piston 124 is at the fully retracted position. Other embodiments may differently control the fully extended and/or retracted positions of the piston (such as, for example, contacting different surfaces with the piston than the surfaces 135 and 131).

With continued reference to FIGS. 1C and 1E, the liquid chamber 114 comprises a first portion 137 that is within the cylindrical sleeve 108, and a second portion 139 that is below the cylindrical sleeve 108 within the bottom cap 106. The first portion 137 and second portion 139 of the liquid chamber 114 are in fluid communication through an opening 133 in the bottom cap 106. As can be seen in FIG. 1C, the opening 133 comprises a width W that is at least as large as, and in this case larger than, a diameter D of the interior surface 129 of the cylindrical sleeve 108. This can be beneficial, for example, because it can help to ensure that the piston 124 removes as much fluid as possible from the pulsation dampener 100 before the fluid solidifies when the pumping system is turned off. Such a configuration is not a requirement, however, in some embodiments may comprise an opening width W that is at least 100%, 90%, 80%, or less of the diameter D of the interior surface 129 of the cylindrical sleeve 108. In some embodiments, it can be desirable for the opening 133 to be directly through a side of the second portion 139 of the liquid chamber 114 (e.g., directly through a side of a cylindrical flow path), without any additional and/or interconnecting flow paths between the opening 133 and the second end 111 of cylinder 108.

Desirably, when the piston 124 is in the fully retracted position, the volume of the first portion 137 of the liquid chamber 114 drops to zero or close to zero. This can be beneficial, for example, to help ensure all (or at least most) of the fluid is able to be removed from the pulsation dampener 100 when the piston 124 is in the fully retracted position and/or when the fluid pumping system is turned off. Additionally, as can be seen in FIGS. 1C and 1E, the second portion 139 of the liquid chamber 114 is desirably similar in diameter to (or slightly larger than), and in line with, the fluid inlet and outlet ports 110, 112. This can, for example, help to allow any fluid that remains in the pulsation dampener 100 to be removed. Another way to describe and/or accomplish this benefit is to utilize a piston with a flat or convex bottom surface (e.g., such as the flat bottom piston 124 of FIG. 1C), and configure the pulsation dampener such that, in the fully retracted position, the lowest point of the piston reaches, is in line with, or extends beyond a tangent to the cylindrical shape of the second portion 139 of the liquid chamber 114 and/or a tangent to the cylindrical inlet and/or outlet passages 180, 182, with the cylindrical inlet and outlet passages 180, 182 extending along a direction that is perpendicular to the direction along which the cylinder 108 extends.

For example, with reference to FIGS. 1C and 1E, the surface 131 that defines the lowest point that the flat bottom of the piston 124 will extend to in the fully retracted position, and that is at the same point as the opening 133, is aligned to be tangent to the cylindrical inner surfaces of the inlet and outlet passages 180, 182, and to extend slightly beyond tangent to the cylindrical inner surface of the second portion 139 of the liquid chamber 114. Such an arrangement can be desirable, because extending beyond tangent to the cylindrical inner surface of the second portion 139 of the liquid chamber 114 will help to create the opening 133, while positioning the flat bottom of the piston 124 to be substantially tangent to the cylindrical inner surfaces of the inlet and outlet passages 180, 182 in the fully retracted position will help to expel all or substantially all fluid from the liquid chamber 114 while not causing the piston 124 to protrude into the flow-through flow path of the pulsation dampener 100 (e.g., a flow path defined by the cylindrical surfaces of passages 180, 182). In some embodiments, the pulsation dampener is configured such that the bottom of the flat bottom piston (and/or the lowest point of a piston that may not have a flat bottom, such as a convex bottom) is tangent to a cylindrical inner surface of an inlet and/or outlet passage of a flow through design when the piston is in the fully retracted position. In some embodiments, the pulsation dampener is configured such that the bottom of the flat bottom piston (and/or the lowest point of a piston that may not have a flat bottom, such as a convex bottom) is within one, two, three, four, or five mm of tangent to a cylindrical inner surface of an inlet and/or outlet passage of a flow through design when the piston is in the fully retracted position. In some embodiments, this concept can be alternatively described as a ratio of how far the bottom of the flat bottom piston (and/or the lowest point of a piston that may not have a flat bottom, such as a convex bottom) is from tangent to a cylindrical inner surface of an inlet and/or outlet passage of a flow-through design when the piston is in the fully retracted position, divided by a diameter of the cylindrical inner surface of the inlet and/or outlet flow passage of the flow through design. In some embodiments, the ratio is no greater than 1%, 5%, 10%, 15%, 20%, or 25%. Although the above examples are given in reference to cylindrical shapes that have a tangent point, some embodiments may utilize shapes other than cylindrical for the inlet and/or outlet passages and/or the second portion of the liquid chamber. In such cases, the above examples can be modified to refer to a highest point of the passage or portion instead of a tangent point of the passage or portion.

With continued reference to FIG. 1C, the pulsation dampener 100 further comprises a first or primary gas chamber 116 that is defined at least partially by the top cap 104, the first end 125 of the piston 124, and a portion of the interior surface 129 of the cylindrical sleeve 108 that is between the top cap 104 and the first end 125 of the piston 124. The first or primary gas chamber 116 can be filled with a pressurized gas in order to bias the piston 124 toward the retracted position. When pulsations or fluctuations in pressure are experienced within the liquid of the liquid chamber 114, the piston 124 can move toward the extended position, thus reducing the volume of the first or primary gas chamber 116 and increasing the pressure within the first or primary gas chamber 116, which will help to absorb and/or dampen such pulsations or fluctuations.

The pulsation dampener 100 further comprises a second or secondary gas chamber 118 that is in fluid communication with the first or primary gas chamber 116 through a plurality of openings 120 (e.g., openings, slots, apertures, and/or the like). In this embodiment, the second gas chamber 118 generally surrounds the first gas chamber 116 and is positioned within an annular space between the cylindrical sleeve 108 and the housing 102. Other embodiments may position the second gas chamber 118 differently, and some embodiments may not even include the second gas chamber 118. Inclusion of the second gas chamber 118 can be beneficial, however. For example, as described above, as the piston 124 moves toward the extended position, the volume of the first gas chamber 116 will decrease, increasing the pressure within the first gas chamber 116. As the volume of the gas acting on the first end 125 of the piston 124 decreases, the force required to move the piston 124 further in the extend direction will also increase. In order to maintain more consistent dampening performance as more and more liquid accumulates within the liquid chamber 114, however, it can be desirable to decrease the amount that the force required to move the piston 124 increases as the piston 124 gets closer to the extended position (e.g., by reducing the slope of a curve that shows the biasing force on the piston 124 versus the position of the piston 124). By including the additional second gas chamber 118 that does not change in volume when the piston 124 moves, there can be less variation in the total volume of gas in the dampener between the retracted and extended positions of the piston 124, thus enabling the dampening performance of the dampener 100 to be more consistent regardless of where in the stroke the piston 124 is currently located. In some embodiments, the volume of the second gas chamber 118 is at least 40% of the volume of the first gas chamber 116 with the piston 124 in the retracted position. In some embodiments, the volume of the second gas chamber 118 is at least 20%, 30%, 50%, or more of the volume of the first gas chamber 116 with the piston 124 in the retracted position.

In the pulsation dampener 100, the openings 120 that fluidly couple the first gas chamber 116 to the second gas chamber 118 are openings through the first end 109 of the cylindrical sleeve 108. Further details of one such opening 120 are shown in the enlarged cross-sectional view of FIG. 1D. Here, it can be seen that the first end 109 of the sleeve 108 is held in place with respect to the top cap 104 by a groove, slot, or depression 146 in the top cap 104. The first end 109 of the sleeve 108 further comprises a plurality of openings or slots 120, however, that are positioned within an additional groove, slot, or depression 144 in the top cap 104, which enables a flow path 122 to allow for fluid communication between the first gas chamber 116 and the second gas chamber 118. It should be noted that, although only one opening 120 and flow path 122 is shown in the cross-sectional view of FIG. 1D, a plurality of the same or similar openings 120 and flow paths 122 may be included.

As shown in FIG. 1D, the groove or depression 144 enables the openings 120 to be positioned beyond the top surface 135 of the top cap 104 along the extend direction of the piston 124. This can be beneficial, for example, because it can enable the piston 124 to extend all the way to the fully extended position (e.g., with the first end 125 of the piston 124 in contact with the top surface 135 of the top cap 104) without closing off the flow paths 122. That said, positioning the openings 120 beyond the top surface 135 in the extend direction is not a requirement, however, and it may even be possible to have the openings 120 be in front of the top surface 135, or at least partially in front of the top surface 135, without closing off the flow paths 122. For example, as described further below with reference to FIGS. 3A and 3B, the piston 124 comprises a first or top end cap 356 that positions the first or top seal 362 at least partially away from the first end 125 of the piston 124. Accordingly, in some embodiments, it can be desirable to position the openings 120 at least beyond the position at which the first or top seal 362 will be at when the piston 124 is in the fully extended position.

Although the embodiment shown in FIGS. 1C, 1D, and 1E has the openings 120 through the sleeve 108, other embodiments may position the openings 120 (and/or the flow paths 122 that they provide for) differently. For example, the top cap 104 may comprise one or more openings that provide for flow paths between the first gas chamber 116 and the second gas chamber 118.

With reference to FIG. 1C, the pulsation dampener 100 further comprises a fill valve 130 that is in fluid communication with the first and second gas chambers 116, 118 in order to introduce pressurized gas into the first and second gas chambers 116, 118 and/or to remove pressurized gas from the first and second gas chambers 116, 118. The fill valve 130 in this embodiment is in direct fluid communication with the first gas chamber 116, and is in indirect fluid communication with the second gas chamber 118 (e.g., through the openings 120), but such a configuration is not a requirement for all embodiments. Further, in this embodiment, the fill valve 130 is connected to a fill valve adapter 132 that is in turn connected to the top cap 104. This also is not a requirement for all embodiments, and the fill valve 130 may alternatively be directly coupled to the top cap 104, coupled to the housing 102, coupled to the bottom cap 106, and/or the like. The fill valve 130 may be any type of valve suitable for the purpose, such as a Schrader valve or the like. In FIG. 1C, it also shows that the adapter 132 includes two openings 151. In use, these openings 151 may be plugged, may have other components attached thereto, such as pressure gauges or sensors, and/or the like.

As mentioned above, the top cap 104 and bottom cap 106 may be sealed to the housing 102 with O-rings 138. Likewise, the cylindrical sleeve 108 may be sealed to the bottom cap 106 with O-rings 158 (see FIG. 1C).

With reference to FIGS. 1C and 1E, as mentioned above, the top cap 104 and bottom 106 may be threadedly coupled to the housing 102. Although it is desirable to pressurize the gas chambers 116, 118, it may also be desirable to ensure that there is not gas pressure within the threaded areas of the housing 102, top cap 104, and bottom cap 106. Accordingly, each of the top cap 104 and bottom cap 106 include features that can help to relieve such pressure in the threaded areas, desirably resulting in the threaded areas being at ambient environmental pressure. Specifically, with reference to FIG. 1E, the bottom cap 106 includes a thread pressure relief channel 148 that is exposed to the environment at a first end and that is exposed to an area between O-ring 138 and threads 149 at a second end. Similarly, with reference to FIG. 1C, the top cap 104 includes a thread pressure relief channel 140 that can be exposed to the environment at a first end and that is exposed to an area between O-ring 138 and threads 159 at a second end. In this embodiment, however, the thread pressure relief channel 140 is also exposed to the second gas chamber 118, and thus a plug 142 is included that can be used to selectively seal off the thread pressure relief channel 140 from the environment. Such a configuration may be beneficial, for example, such as to provide another access port to the pressure within the gas chambers where a pressure gauge, sensor, and/or the like may be connected.

As mentioned above, some embodiments of pulsation dampeners disclosed herein may include the ability to detect the current position of the piston 124 within the pulsation dampener 100. Specifically, with reference to FIGS. 1C and 1E, the pulsation dampener 100 comprises a proximity sensor 134 coupled to the bottom cap 106, and a magnet 136 embedded within the piston 124. The proximity sensor 134 may be any type of sensor capable of detecting the presence or non-presence of a magnetic field (e.g., a binary sensor), and/or any type of sensor capable of detecting a strength of a magnetic field (e.g., with the detected strength being correlated to a distance that the magnet 136 of the piston 124 is away from the proximity sensor 134). For example, the proximity sensor 134 may comprise a Hall effect sensor, a reed switch, and/or the like. The magnet 136 may be any type of magnet that provides a sufficient magnetic field for detection by the proximity sensor 134. In some embodiments, the magnet 136 is a relatively high-powered magnet, such as a rare earth magnet.

Inclusion of the proximity sensor 134 can be beneficial, for example, to enable detection of whether the pulsation dampener 100 is operating as intended. For example, monitoring of the proximity sensor 134 may be useful in determining the correct pressure charge to include in the first and second gas chambers 116, 118 while operating a fluid piping system that is connected to the pulsation dampener 100. For example, if monitoring of the proximity sensor 134 shows that the piston 124 is not moving away from the retracted position as much as expected, pressure within the gas chambers may be reduced. Likewise, if monitoring of the proximity sensor 134 shows that the piston 124 is too easily moving away from the retracted position (e.g., the piston 124 is reaching the fully extended position in response to a smaller pressure fluctuations than intended), pressure within the gas chambers may be increased. Additionally, monitoring of the proximity sensor 134 may be used to detect a situation where, even with a fluid pumping system off and thus no pressure in the liquid chamber 114, the piston 124 has not fully retracted to the fully retracted position. This may be indicative of a viscous fluid having solidified within the liquid chamber 114, and can enable an operator of the system to act on such information, such as by cleaning the system.

As described above, inclusion of the cylindrical sleeve 108 can be beneficial, for example, because it can enable addition of a second gas chamber 118 that is in fluid communication with the first or primary gas chamber 116 which can have a number of benefits, including reducing the rate of increase in resistance to movement of the piston 124 toward the extended position. Inclusion of such a cylindrical sleeve 108 that seals against the piston 124 can also have other benefits. For example, it may be easier to precision machine or hone the interior surface 129 of the cylinder or sleeve 108 than the housing 102. As another example, the cylinder 108 may be easily replaceable with a new cylinder if, for example, the interior surface 129 of the cylinder 108 becomes damaged, such as as a result of some viscous fluid solidifying within the liquid chamber 114. In such a situation, it may be easier and less costly to replace the cylinder 108 than to replace the entire pulsation dampener. As another example, alternative designs may be produced that, for example, utilize differently sized housings 102 with the same size cylinder 108, leading to the ability to adjust the size of the secondary gas chamber 118 without requiring production of different pistons. As another example, in some situations it may be desirable to produce the housing 102 from a different material than the piston 124 and/or from a material that has a different coefficient of thermal expansion than the piston 124. In such a situation, the cylinder 108 may be produced from a material that is the same or at least has a same or similar coefficient of thermal expansion to the piston 124. As mentioned above, however, although inclusion of the cylinder 108 can have a number of benefits, alternative embodiments may not include the cylinder 108, and may, for example, configure the piston 124 to seal directly against the interior surface of the housing 102.

### Example Piston Construction

Turning to FIGS. 3A and 3B, these figures illustrate additional details of the piston 124 of the fluid pulsation dampener 100 of FIG. 1A. Although this particular piston 124 is used in the pulsation demo 100, the same or similar piston 124 may also be used in other pulsation dampeners, including pulsation dampeners that utilize a single gas chamber as opposed to the dual chamber/dual wall design of the pulsation dampener 100. For example, the piston 124 and housing 102 could be modified such that the piston 124 seals against the housing 102 instead of the cylinder 108.

FIG. 3A is a cross-sectional view of the piston 124, and FIG. 3B is an exploded view. The piston 124 comprises a main body 352 that has a glide ring 354 coupled thereto (e.g., positioned within groove 355). The main body 352 may be sized to have a slightly smaller diameter than the inside diameter of the cylinder 108 of the pulsation dampener 100. The glide ring 354 may, for example, be sized slightly larger than the diameter of the main body 352, such as to help guide the piston 124 along the cylinder 108 while reducing wear on the main body 352 and/or on the cylinder 108. The glide ring 354 may be formed from a variety of materials, such as a polymer (including but not limited to perfluoroelastomer), brass, and/or the like.

The piston 124 further comprises a first or top end cap 356 and a second or bottom end cap 358, each of which are attached to the main body 352 of the piston 124 using a plurality of fasteners 368. In this case, the plurality of fasteners 368 comprise screws that are threaded into the main body 352, but other fastening means may be used. Desirably, alignment features 357 are also included which help to align the end caps 356, 358 to the main body 352 along a common central axis. In this case, the alignment features 357 comprise protrusions on the end caps 356, 358 that fit into complementary depressions or holes in the main body 352. Other ways of aligning the caps 356, 358 to the main body 352 may also be used.

When the first and second end caps 356, 358 are coupled to the main body 352, they form corresponding annular grooves or spaces 360, 364 therebetween. Within the top groove 360 is positioned at a first or top seal 362, and within the bottom groove 364 is positioned a second or bottom seal 366. In this embodiment, the seals 362, 366 each comprise high-performance U-cup seal rings. For example, the seals 362, 366 each comprise a body 391 having an outer lip 393 and an inner lip 395 extending therefrom. The seals 362, 366 also each comprise a lip support structure 397 that is intended to, for example, force or keep engagement of the lips 393, 395 with the surface they are sealing against (such as a surface of the main body 352 or the interior surface 129 of the cylinder or cylindrical sleeve 108). The lip support structure 397 may comprise, for example, an O-ring, a metal spring, and/or the like.

Desirably, at least the bottom seal 366—and in some embodiments both the top and bottom seals 362, 366—comprises a high-performance polymer material that is resistant to corrosive fluids and to extreme temperatures. For example, the seals 362, 366 may comprise a perfluoroelastomer material that is capable of withstanding temperatures of up to 446° F. or higher without damage. As discussed above, such a configuration can be desirable particularly in use cases where a fluid that is solid at room temperature is being pumped at higher temperatures to maintain the fluid in a liquid state. Use of such materials is not a requirement in all embodiments, however, and particularly is not required in an embodiment that is not necessarily intended to be used with such high temperature fluids.

Another advantage of using U-cup seal rings for the seals 362, 366 (or at least for the bottom seal 366 that is exposed to the liquid chamber 114) is that the outer lip 393 can perform a wiping function on the interior surface 129 of the cylinder 108. This can help to clean the interior surface 129 of the cylinder 108, to ensure that as much fluid as is practical is removed from the pulsation dampener 100 before the fluid solidifies as it reduces in temperature.

Some embodiments may include the annular grooves 360, 364 for positioning therein of the seals 362, 366 without having the end caps 356, 358 be detachable from the main body 352. In such an embodiment, the seals may, for example, be stretched out in order to install them into the grooves 360, 364. It can be desirable to include the removable end caps 356, 358, however, such as to avoid damaging the seals 362, 364 by stretching them. This can be particularly beneficial with high-performance U-cup seals that may be more prone to damage from such stretching than a more typical seal. Other types of seals (e.g., more typical piston seals) may be used in some embodiments, however, particularly in embodiments that may not necessarily be intended for use with high temperature fluids.

Desirably, the interior surface 129 of the cylinder 108 comprises a honed surface finish. This can, for example, lead to better sealing of the seals 362, 366 against the interior surface 129 than if the surface 129 were not honed. Further, desirably, the cylindrical sleeve 108 and at least of the main body 352 of the piston 124 comprise either the same material or materials that have the same or similar coefficient of thermal expansion. For example, the cylinder 108 and main body 352 may both comprise steel, stainless steel, and/or the like. Having materials with the same or similar coefficient of thermal expansion can be desirable, particularly in a use case where high temperature fluids are being pumped, which may cause significant thermal expansion of components of the pulsation dampener 100. In such a situation, having materials with different or significantly different coefficients of thermal expansion could cause the fit between the piston 124 and the cylinder 108 to become too tight, to become too loose, and/or the like.

In some embodiments, all or most of the components of the pulsation dampener 100 comprise stainless steel, which can be beneficial both to resist corrosion and to resist being damaged by high temperature fluids (such as fluids at up to 446° F. or more). For example, in some embodiments, at least the piston main body 352, piston top end cap 356, piston bottom end cap 358, housing 102, cylinder 108, top cap 104, and bottom cap 106 comprise stainless steel.

With continued reference to FIG. 3A, this figure also shows that the magnet 136 is placed within a pocket in the bottom of the main body 352, and held in place by the bottom end cap 358. Other configurations for positioning and/or retaining the magnet 136 may be used. In some cases, the magnet 136 may be exposed at the bottom of the piston 124. Such a configuration may not be as desirable, however, such as because the material of the magnet 136 may be less resistant to corrosion or other damage caused by contact with the fluid being pumped than the material of the bottom end cap 358 (such as stainless steel).

### Additional Information

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

What is claimed is:

1. A fluid pulsation dampener comprising:
a housing having a first end and a second end;
a first cap connected to the first end of the housing;
a second cap connected to the second end of the housing;
a cylindrical sleeve having a first end and a second end, the cylindrical sleeve positioned within the housing and captured between the first cap and the second cap;
a piston having a first end and a second end, the piston being slidably coupled to the cylindrical sleeve such that the piston can move between an extended position and a retracted position,
wherein the first end of the piston comprises a first U-cup seal that seals against an interior surface of the cylindrical sleeve, and the second end of the piston comprises a second U-cup seal that seals against the interior surface of the cylindrical sleeve;
a liquid chamber defined at least partially by the second cap, the second end of the piston, and a portion of the interior surface of the cylindrical sleeve that is between the second cap and the second end of the piston;
a fluid inlet passage and a fluid outlet passage for fluidly coupling the fluid pulsation dampener to a fluid pumping system in a flow-through arrangement, the fluid inlet passage and the fluid outlet passage being in fluid communication with the liquid chamber and extending in a direction perpendicular to a direction along which the cylindrical sleeve extends,
wherein the piston is shaped such that, with the piston in the retracted position:
a lowest point of the piston is tangent to an inner surface of at least one of the fluid inlet passage or the fluid outlet passage, or
the lowest point of the piston is a distance from tangent to the inner surface of the at least one of the fluid inlet passage or the fluid outlet passage, with the distance being no more than 20% of a diameter of the inner surface of the at least one of the fluid inlet passage or the fluid outlet passage;
a first gas chamber defined at least partially by the first cap, the first end of the piston, and a portion of the interior surface of the cylindrical sleeve that is between the first cap and the first end of the piston;
a second gas chamber positioned within an annular space between the cylindrical sleeve and the housing, the second gas chamber defined at least partially by the first cap, the second cap, an interior surface of the housing, and an exterior surface of the cylindrical sleeve;
one or more openings that fluidly couple the first gas chamber to the second gas chamber; and
a proximity sensor coupled to the second cap, wherein the piston further comprises a magnet, and wherein the proximity sensor is positioned such that it can detect the magnet of the piston, at least when the piston is in the retracted position.

2. The fluid pulsation dampener of claim 1, wherein all parts of the fluid pulsation dampener that define the liquid chamber are capable of being exposed to a liquid heated to a temperature of 446° F. without damage.

3. The fluid pulsation dampener of claim 1, wherein at least the second U-cup seal comprises a perfluoroelastomer material.

4. The fluid pulsation dampener of claim 1, wherein the piston comprises a main body, a first cap, and a second cap,
wherein the main body and the first cap of the piston form an annular groove therebetween within which first U-cup seal is positioned, and
wherein the main body and the second cap of the piston form an annular groove therebetween within which second U-cup seal is positioned.

5. The fluid pulsation dampener of claim 1, wherein the piston comprises a flat bottom.

6. The fluid pulsation dampener of claim 1, wherein the interior surface of the cylindrical sleeve comprises a honed surface.

7. The fluid pulsation dampener of claim 1, further comprising a fill valve coupled to the first cap for introducing pressurized gas into the first gas chamber and the second gas chamber.

8. The fluid pulsation dampener of claim 1, wherein the cylindrical sleeve and a main body of the piston each comprise a material having a same coefficient of thermal expansion.

9. The fluid pulsation dampener of claim 1, wherein the cylindrical sleeve and a main body of the piston each comprise stainless steel.

10. The fluid pulsation dampener of claim 1, wherein the piston can move in a first direction, toward the first end of the housing, and in a second, opposite direction, toward the second end of the housing,
wherein the first cap comprises a surface positioned to limit movement of the piston in the first direction, and
wherein the one or more openings that fluidly couple the first gas chamber to the second gas chamber are positioned beyond the surface of the first cap in the first direction.

11. The fluid pulsation dampener of claim 10, wherein the first end of the cylindrical sleeve is positioned within a groove of the first cap that extends beyond the surface of the first cap in the first direction.

12. The fluid pulsation dampener of claim 11, wherein the first end of the cylindrical sleeve comprises the one or more openings that fluidly couple the first gas chamber to the second gas chamber.

13. A fluid pulsation dampener comprising:
a housing having a first end and a second end;
a piston having a first end and a second end, the piston being moveable with respect to the housing along a first direction between an extended position and a retracted position,
a gas chamber that is exposed to the first end of the piston;
a liquid chamber that is exposed to the second end of the piston,
wherein the piston comprises one or more seals that seal the gas chamber from the liquid chamber;
a fluid inlet passage and a fluid outlet passage for fluidly coupling the fluid pulsation dampener to a fluid pumping system in a flow-through arrangement, the fluid inlet passage and the fluid outlet passage being in fluid communication with the liquid chamber and extending in a direction perpendicular to the first direction,
wherein the piston is shaped such that, with the piston in the retracted position:
a lowest point of the piston is tangent to an inner surface of at least one of the fluid inlet passage or the fluid outlet passage, or
the lowest point of the piston is a distance from tangent to the inner surface of the at least one of the fluid inlet passage or the fluid outlet passage, with the distance being no more than 20% of a diameter of the inner surface of the at least one of the fluid inlet passage or the fluid outlet passage.

14. The fluid pulsation dampener of claim 13, wherein the second end of the piston comprises a flat surface, and the lowest point of the piston is defined by the flat surface.

15. The fluid pulsation dampener of claim 13, wherein the one or more seals of the piston comprises at least one U-cup seal comprising a perfluoroelastomer material.

16. The fluid pulsation dampener of claim 13, wherein all parts of the fluid pulsation dampener that define the liquid chamber are capable of being exposed to a liquid heated to a temperature of 446° F. without damage.

17. The fluid pulsation dampener of claim 13, wherein the piston further comprise a magnet, and where the fluid pulsation dampener further comprises a proximity sensor positioned such that it can detect the magnet of the piston, at least when the piston is positioned in the retracted position.

18. A fluid pulsation dampener comprising:
a housing having a first end and a second end;
a first cap connected to the first end of the housing;
a second cap connected to the second end of the housing;
a cylindrical sleeve having a first end and a second end, the cylindrical sleeve positioned within the housing;
a piston having a first end and a second end, the piston being slidably coupled to the cylindrical sleeve such that the piston can move between a retracted position and an extended position, and the piston comprising one or more seals that seal against an interior surface of the cylindrical sleeve;
a liquid chamber defined at least partially by the second cap, the second end of the piston, and a portion of the interior surface of the cylindrical sleeve that is between the second cap and the second end of the piston;
one or more fluid ports in fluid communication with the liquid chamber;
a first gas chamber defined at least partially by the first cap, the first end of the piston, and a portion of the interior surface of the cylindrical sleeve that is between the first cap and the first end of the piston;
a second gas chamber positioned within a space between the cylindrical sleeve and the housing, the second gas chamber defined at least partially by an interior surface of the housing and an exterior surface of the cylindrical sleeve;
one or more openings that fluidly couple the first gas chamber to the second gas chamber; and
a proximity sensor coupled to the second cap, wherein the piston further comprises a magnet, and wherein the proximity sensor is positioned such that it can detect the magnet of the piston, at least when the piston is in the retracted position.

19. The fluid pulsation dampener of claim 18, wherein the cylindrical sleeve is captured between the first cap and the second cap.

20. The fluid pulsation dampener of claim 18, wherein the piston can move in a first direction, toward the first end of the housing, and in a second, opposite direction, toward the second end of the housing, and
wherein the one or more openings that fluidly couple the first gas chamber to the second gas chamber are positioned beyond a furthest position any of the one or more seals of the piston can move to in the first direction.

21. The fluid pulsation dampener of claim 20, wherein the first end of the cylindrical sleeve is positioned within a groove of the first cap, and wherein the first end of the cylindrical sleeve comprises the one or more openings that fluidly couple the first gas chamber to the second gas chamber.

22. The fluid pulsation dampener of claim 18, wherein the cylindrical sleeve and a main body of the piston each comprise a material having a same coefficient of thermal expansion.

23. The fluid pulsation dampener of claim 18, wherein the cylindrical sleeve and a main body of the piston each comprise stainless steel.

24. The fluid pulsation dampener of claim 18, wherein the one or more seals of the piston comprises at least one U-cup seal comprising a perfluoroelastomer material.
